(19) United States
(12) Patent Application Publication
(10) Pub. No.: US 2005/0132897 A1
(43) Pub. Date: Jun. 23, 2005

(54) All-mighty portable cooker toaster oven

(76) Inventor: Ignacio R. Umali, Covina, CA (US)

Correspondence Address: IGNACIO R. UMALI, 953 CALMGROVE AVE., COVINA, CA, 91724, US

(21) Appl. No.: 10/745,880

(22) Filed: Dec. 23, 2003

(51) Int. Cl. A47J 9/00; A23L 1/00

(52) U.S. Cl. 99/339

(57) ABSTRACT

A multi-purpose portable cooker-toaster oven economically priced and will give long lasting service with almost no maintenance and repair needed for as long as you have it. No built-in heating devices above and under, no wirings to break, no programming involved and above all this All-Mighty cooker can cook almost anything, anyplace and anywhere you go. This hot pandesal (dinner rolls) portable cooker-toaster oven can cook; bake, broil, toast, bar-b-que, fry and can do simmer cooking too. Re-heating dinner rolls, leftover pizza, leftover fried chickens any kind of food that you want to have a crunchy result this cooker-toaster oven can do it for you. This portable cooker-toaster oven can be used any place you go. You can use this in the mountain where firewood's is the only source of energy and you can also use this oven in the city where charcoals, electric and gas energy are available.

### BACKGROUND OF THE INVENTION

1. Field of Invention

This invention relates to a portable cookware-oven for simmer cooking, baking, toasting, broiling, and frying and re-heating foods.

2. Background of the Invention

People from all walks of life differ the way they live and cook their own foods. Some people prefer to live in the city where energy sources are plenty and some prefers a rural life where the only source of energy are charcoals and fire woods.

This present invention fits the above descriptions because this cooker-oven is suitable for all energy sources including firewoods; charcoals, modern standard residential electric and gas stove burners.

This cooker-oven can be used indoors and outdoors because this cooker-oven does not have built-in heating devices above or under the cooker-oven

This cooker-oven bakes, broils, toast, fry and simmers and this cooker-oven gives an excellent result in re-heating leftovers like pizza, dinner rolls, fried chickens and many more.

### OBJECTS OF THE INVENTION

A principal object of the present invention is to introduce to the market a more simpler economical almost maintenance free Portable Cooker-Toaster/Broiler oven that can last almost a lifetime.

A Portable Cooker-Toaster Oven that can be used any place as desired, anywhere in the whole world.

A Portable Cooker-Toaster Oven that has no limits as far as cooking, baking and toasting is concerned.

A Portable Cooker-Toaster Oven that can be used in cooking, broiling, toasting, frying, simmering and above all is suitable on all energy sources including firewood's, charcoals, electric stoves and gas stove burners.

A Portable Cooker-Toaster Oven so easy to use, no built-in heating devices above and or under the oven, no electrical wirings to break and no programming involved.

A Portable Cooker-Toaster/Broiler Oven that can give a crunchy result in baking, toasting dinner rolls (hot pandisal in Filipino) and re-heating leftovers that can taste like from fresh.

### BRIEF DESCRIPTION OF THE DRAWINGS

Presentation of the present invention will be readily understood by references to the following description when considered in connection with accompanying drawings in which:

FIG. 1: is the cross section of the two heat inlets Portable Cooker-Toaster Oven 1A, the present invention comprises of a unique design pan body (pot) 1 with two half-circle cuts 2 & 3, a heat control unit 6A and a revolutionary design see thru glass cover assembly 4A with a heat resistant plastic knob 5.

FIG. 1(A): is the cross-section of the two heat inlets cooker-toaster oven 1A showing the frying pan 13, the broiling pot 14 and the stainless steel wire grill 15 for frying and broiling.

FIG. 1(B): is the cross-section of the two heat inlets 1A showing the simmering pot 16 and the stainless steel wire grill 15 for simmer cooking and broiling.

FIG. 2: is the bottom view of the pan body (pot) 1 one of the embodiments of the two heat inlets oven 1A showing the two half-circle cuts 2 & 3.

FIG. 3: is the cross-sectional view of FIG. 2 the bottom view of the pan body 1 showing ends of 2 & 3 lifted at a certain angle?

FIG. 4: is the bottom view of the see thru glass cover assembly 4A showing the heat resistant plastic knob 5 as shown in broken line.

FIG. 5: is the cross-section of the glass cover assembly 4A showing the heat resistant plastic knob 5.

FIG. 6: is the side view of the heat control unit (assembly) 6A one of the embodiments of the two inlets portable cooker-toaster oven 1A.

FIG. 7: is the cross-sectional view of FIG. 8 the welded wire grill 6 one of the embodiments of the heat control unit 6A.

FIG. 8: is the top view of FIG. 7 the welded stainless steel wire grill 6.

FIG. 9: is the cross-section of the tertiary heat control/oil pan 8 one of the embodiments of the heat control unit (assembly) 6A as shown in FIG. 6.

FIG. 10: is the top view of FIG. 9 the tertiary heat control/oil pan 8 shown in FIG. 6.

FIG. 11: is the cross-sectional view of FIG. 12 the secondary heat control 7 one of the embodiments of the heat control unit 6A as shown in FIG. 6.

FIG. 12: is the top view of FIG. 11 the secondary heat control 7.

FIG. 13: is the bolt 9 one of the embodiments of the heat control unit 6A as shown in FIG. 6.

FIG. 14 is the spacer 11 one of the embodiments of the heat control unit 6A as shown in FIG. 6.

FIG. 15: is the longer version of the Portable Cooker-Toaster Oven 17A. The revolutionary base of the longer pan body (Pot) 17 has four half-circle cuts 2 & 3 with the matching see thru glass cover 18 with two plastic heat resistant knobs 5.

FIG. 16: is the bottom view of the longer pan body (pot) 17 showing the four half-circle cuts 2 & 3.

FIG. 17: is the cross-sectional view of FIG. 16 the longer pan body 17. The bottom of the pan body (pot) 17 has four half-circle cuts 2 & 3. Each end of the cut is lifted at a certain angle.

FIG. 18: is the bottom view of the longer glass cover 18 one of the embodiments of the longer portable oven 17A showing the two heat resistant plastic knobs shown in broken lines.

FIG. 19: is the cross section of FIG. 18 showing the two heat resistant plastic knobs 5.

### DETAILED DESCRIPTION OF THE PREFERED EMBODIMENT:

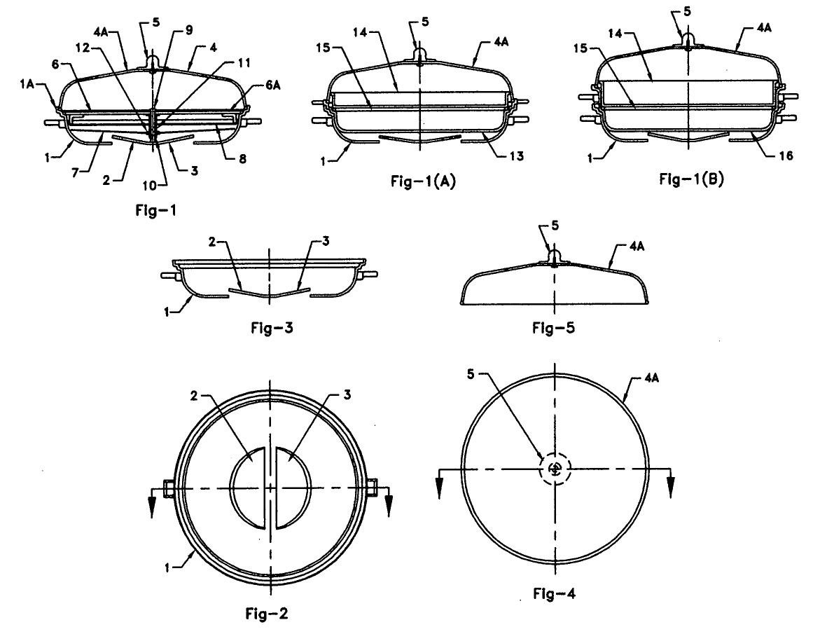

Referring now to the drawings wherein like reference numerals designate identical or corresponding parts throughout the several views particularly to FIG. 1 wherein a Hot Pandesal (Dinner Rolls) Portable Cooker-Toaster Oven, Broiler, Bar-b-queer in accordance with the present invention, generally designated 1A, comprises of a revolutionary pan body 1 having two half-circle cuts 2 & 3 further shown in FIG. 2 the bottom view of the regular size pan body 1. The ends of the two half circle cuts 2 & 3 at the bottom of the pan body 1 are lifted at a certain angle for heat entrance and at the same time served as the primary heat control as shown in FIG. 2 and FIG. 3.

The regular size Hot Pandesal (Dinner Rolls) Portable Cooker-Toaster Oven, Broiler, Bar-b-queer 1A further comprises of at least one revolutionary see thru glass cover 4A having one heat resistant plastic knob 5 shown in FIG. 4 the bottom view of the glass cover & FIG. 5 the cross section of FIG. 4 the see thru glass cover.

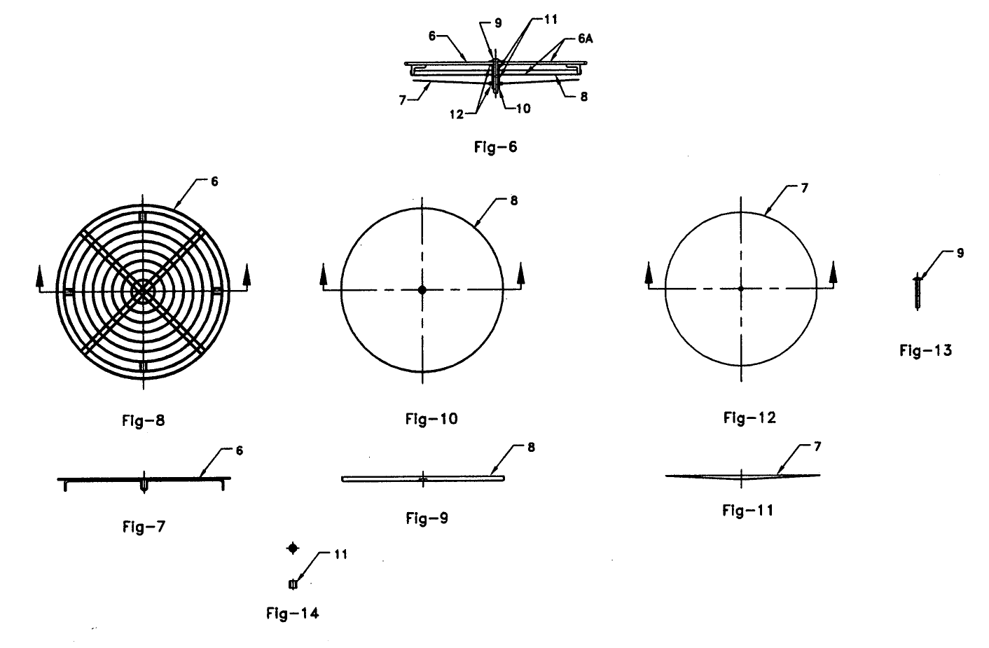

The regular size Hot Pandesal (Dinner Rolls) Portable Cooker-Toaster Oven 1A further comprises of one heat control unit (assembly) 6A as shown in FIG. 6. The heat control unit 6A also comprises of a secondary heat control plate 7 shown in FIG. 11 and a tertiary heat control/oil pan 8 clearly shown in FIG. 9 for clarity. FIG. 10 is the top view of FIG. 9 the tertiary heat control/oil pan 8. The intense heat that passes thru the heat entrance is gradually reduced by the series of heat controls inside the oven before circulating around the cooking chamber. The cooking chamber is the space between wire grill and the ceiling of the glass cover.

The Portable Cooker-Toaster Oven 1A further comprises of a flying pan 13, a stainless steel wire grill 15 as shown in FIG. 1(A), a simmering pot 14 and a stainless steel wire grill as shown in FIG. 1(B). The heat control unit 6A, the flying pan 13 and the simmering pot 14 are interchangeable according to the kind of food to be cooked.

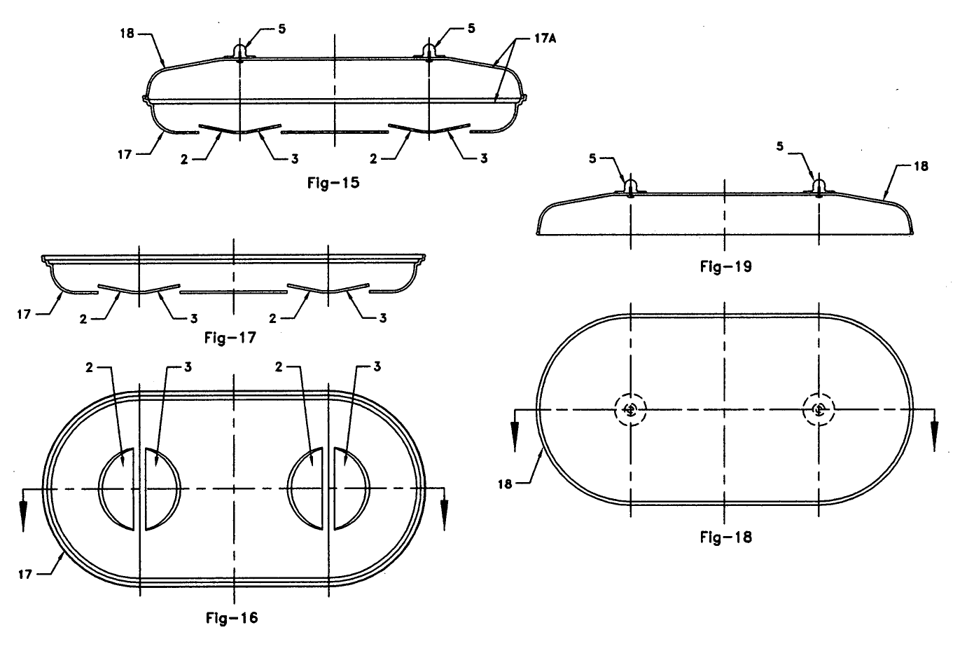

Referring now to the drawing particularly to FIG. 15 the longer version of The Hot Pandesal (Dinner Rolls) Portable Cooker-Toaster Oven, Broiler, Bar-b-queer generally designated 17A, comprises of a longer pan body 17 having four half-circle cuts 2 & 3 on the left and on the right hand side of the pan body 17. FIG. 16 is the bottom view of the longer pan body 17 & FIG. 17 is the cross section of the longer pan body 17 showing the four half-circle cuts 2 & 3 lifted at a certain angle for heat entrance and at the same time serve as the primary heat control.

The longer version of the Portable Oven 17A further comprises of one longer see thru glass cover 18. FIG. 18 & FIG. 19 is the bottom view and the cross sectional view of the longer glass cover 18.

The regular size (two half-circle cuts) Portable Toaster Oven 1A use one Heat Control (unit) assembly 6A.

The longer size (four half-circle cuts) Portable Toaster Oven 17A use two Heat Control Units 6A.

The half circle cuts at the bottom of the main pot body whose ends are lifted at a certain angle is so different from the existing pot and so functional in the sense that the diameter of the half circle cuts and the angle of this cuts are the several secrets of this design.

The unseen conversion of the intense heat passing thru the half circle cuts which is the heat entrance/primary heat control and further reduced by another heat control plate called the secondary heat control plate and finally condensed by the heat control plate/oil pan that circulate inside the heat chamber gives unbelievable result.

The distances from the top of the angled cuts to the secondary heat control plate, from the secondary heat control plate to the tertiary heat control/oil pan, from the tertiary heat control to the ceiling of the glass cover are so vital to the best baking, toasting, broiling and reheating results.

1. A multi purpose Portable Cooker-Toaster oven called The All-Mighty Cooker, “The Hot Pandesal (Dinner Rolls) Portable Toaster Oven/Broiler/Bar-b-queer” that can be used not only on standard and modern residential electric and gas stove burners is also suitable for all energy sources including burning woods and or charcoals comprising.
A revolutionary design pan body (pot) that has two half-circle cuts at the bottom of the pot.
A functional design clears glass cover with a heat resistant plastic knob.
A heat control unit (assembly), compose of series of heat control plates to steps by steps gradually reduce the intensity of heat coming in to the oven.
A frying pan and a wire grill in place of a heat control unit for frying and broiling.
A simmering pot in place of a heat control unit for broiling and simmer cooking.
A uniquely design pan body (pot) that has four half-circle cuts at the bottom of the pan body (pot). This is the longer version of the Hot Pandesal (Dinner Rolls) Cooker-Toaster Oven.
A longer design glass covers for the four half circle cuts pan body. The pan body (pot) of claim 1 has two half-circle cuts at the bottom and both end of the cuts are lifted at a certain angle for heat entrance and at the same time serve as the primary heat control.

2. The see thru glass cover of claim 1that has at least one heat resistant plastic knob serve as the viewing area to see what is going on inside the oven while cooking.

3. The heat control unit of claim 1 further comprising of series of heat control plates the secondary heat control plate and the tertiary heat control/oil pan. The heat control/oil pan serves as the final heat control, food cramps and grease catcher.

4. The heat control unit of claim 1 further comprises of a stainless steel wire grill element.

5. The hot pandesal (dinner rolls) portable cooker-toaster oven of the present invention further comprises of a frying pan, a wire grill and a pot in place of the heat control unit.

6. The hot pandesal (dinner rolls) portable cooker-toaster oven of the present invention further comprises of another pot, a simmering pot and a wire grill in place of the heat control unit.

7. The frying pan, the pots, the simmering pot, the wire grill are interchangeable with the heat control unit depending upon the kind of food to be cooked.

8. The pan body (pot) and the glass cover of the longer size cooker-toaster oven are two times longer than the regular size cooker-oven.

9. The longer size portable toaster oven of claim 1 has two-heat control assembly placed side by side inside the oven.
